(19) United States
(12) Patent Application Publication
(10) Pub. No.: US 2003/0168512 A1
(43) Pub. Date: Sep. 11, 2003

(54) Optical reader having position responsive decode launch circuit

(75) Inventors: Andrew Longacre JR., Skaneateles, NY (US); William H. Havens, Marcellus, NY (US); Robert J. Hennick, Auburn, NY (US); Vivian L. Hunter, Baldwinsville, NY (US); John Izzo, Auburn, NY (US); Michael D. Robinson, Weedsport, NY (US)

Correspondence Address: WALL MARJAMA & BILINSKI, 101 SOUTH SALINA STREET, SUITE 400, SYRACUSE, NY, 13202, US

(73) Assignee: Hand Held Products, Inc.

(21) Appl. No.: 10/339,281

(22) Filed: Jan. 9, 2003

Related U.S. Application Data
(63) Continuation-in-part of application No. 10/093,140, filed on Mar. 7, 2002.
(63) Continuation-in-part of application No. 10/252,484, filed on Sep. 23, 2002.

(51) Int. Cl. G06K 7/10; G06K 7/14

(52) U.S. Cl. 235/454

(57) ABSTRACT

A one-dimensional optical reader which senses a position of a decodable symbol representation in captured image data and which utilizes the sensed position information to determine whether to launch a decoding algorithm to decode the symbol representation.

### CROSS REFERENCE

This application is a continuation-in-part of U.S. Application Ser. No. 10/093,140 filed Mar. 7, 2002 entitled “Optical Reader Aiming Assembly Comprising Aperture” this application is also a continuation-in-part of application Ser. No. 10/252,484 filed Sep. 23, 2002 entitled “Long Range Optical Reader”. The priorities of both of the above applications are claimed and both of the above applications are incorporated herein by reference.

### FIELD OF THE INVENTION

This invention relates generally to optical readers and specifically to an optical reader having a symbol position responsive decode launch circuit.

### BACKGROUND OF THE INVENTION

On certain packaging labels, products, identification cards, and the like, it is become common to include more than one bar code symbol. Substrates having more than one bar code symbol are often includes in user manuals of many bar code readers. For example, FIG. 6 shows a bar code symbol programming “menu sheet”. The menu sheet includes several closely spaced bar codes.

Technological advances such as those made by the assignee, described in for example, Application Ser. No. 10/328,939 filed Dec. 23, 2002 entitled “Autodiscriminating Optical Reader, incorporated herein by reference, Attorney Docket No. 283-361.02, entitled “Optical Reader System Comprising Digital Conversion”, filed Jan. 9, 2003, incorporated herein by reference; Attorney Docket No. 283-368, entitled “Analog-to-Digital Converter with Automatic Range and sensitivity Adjustment”, filed Jan. 9, 2003, incorporated herein by reference; attorney Docket No. 283-374.01, entitled “Decoder Board for an Optical Reader Utilizing a Plurality of Imaging Modules”, filed Jan. 9, 2003, incorporated herein by reference; and Attorney Docket No. 283-374.02, entitled “Manufacturing Methods for a Decoder Board for an Optical Reader Utilizing a Plurality of Imaging Formats, filed Jan. 9, 2003, incorporated herein by reference, have improved the depth of field of optical readers. Whereas early optical readers operated only at contact or near contact distances, image sensor based optical readers soon to be available from Hand Held Products, Inc. (HHP, Inc.) of Skaneateles Falls, N.Y., are operable at up to several feet, with increasingly long distances expected in the future. Despite the availability of optical readers having longer reader distances, lower cost “contact” bar code readers are still being sold.

With a contact type optical reader, there is little likelihood that a user will decode a decodable symbol other than the one he intends to decode. Using a contact type reader, the user places the reader in contact with the bar code intended to be read, pulls a reader trigger and the bar code is decoded.

At longer reading distances, however, aiming of an optical reader can be more difficult. At longer reading distances, there is a possibility, especially with the prevalence of multiple symbol substrates, that more than one bar code will be in the field of view of an optical reader. That is, at longer reading distances, with reference to the menu sheet of FIG. 6, representation of symbol 6010 and a representation of symbol 6012 can easily be captured in the same slice image data. If there is more than one symbol within a field of view of an optical reader, there is a possibility that a decodable symbol other than the symbol intended to be subjected to decoding will be decoded. It can be seen, with reference to the menu sheet example of FIG. 6, that the decoding of a symbol other than an “intended to be decoded” symbol would result in the optical reader being programmed in the wrong way.

There is a need for an optical reader configured so that a decodable symbol proximate a symbol a user intends to decode is not unintentionally decoded.

### SUMMARY OF THE INVENTION

According to its major aspects and broadly stated the present invention is a ID optical reader which senses a position of symbol representation in a captured slice image, and which utilizes the sensed position data in determining whether or not to launch a decoding algorithm to decode the sensed symbol representation.

According to one specific operating method of the invention, a reader captures a slice image frame of data, senses a position of a system representation in the slice image representation, and decodes the symbol representation if a part of the symbol representation is within a predetermined “valid zone”. The valid zone maybe a collection of center pixel positions of an image map, such as the middle 20 percent of pixel positions of an image map.

In another embodiment of the invention, a reader captures a slice frame of image data, senses all decodable symbol in the slice image, and issues a position score to each sensed symbol representation. The reader then attempts to decode the symbol having the highest position score.

These and other details and advantages will become apparent from the detailed description of the preferred embodiment hereinbelow.

### BRIEF DESCRIPTION OF THE DRAWING

For a further understanding of these and objects of the invention, reference will be made to the following detailed description of the invention which is to be read in connection with the accompanying drawing, wherein:

FIGS. 1a and 1b are scan diagrams illustrating the invention;

FIG. 2a is an exploded view of an optical reader in which the invention may be incorporated;

FIG. 2b is a perspective view of an optical reader in which the invention may be incorporated.

FIGS. 2c-2d are perspective view of an imaging module;

FIG. 2e is a top view of an imaging module;

FIG. 2f is a front cross sectional view taken along line f-f of FIG. 2e;

FIG. 2g is a front view of the imaging module of FIG. 2e, with modified baffles;

FIG. 2h is an exploded view of the baffle and optical member assembly of the module of FIGS. 2c-2e;

FIG. 3 is a block diagram of an optical reader in which the invention may be incorporated;

FIGS. 4a and 4b are perspective views on an imaging module including a laser pointer aimer.

FIG. 4c is a schematic view of the aiming system of the imaging module of FIGS. 2c-2e;

FIGS. 4d-4f and 4k-4m are schematic views of various aiming systems projecting aiming patterns having center-indicating features;

FIGS. 4g-4j are examples of aiming patterns having center-indicating features;

FIGS. 5a and 5b are flow diagrams illustrating operating modes according to the invention;

FIG. 5c is an exemplary representation of an image map;

FIGS. 5d-5f are schematic views of optical readers having menu interfaces allowing reprogramming of the reader;

FIG. 6 is an example of a reprogramming menu sheet;

FIG. 7 is a scan map of a prior art optical reader.

### DESCRIPTION OF THE INVENTION

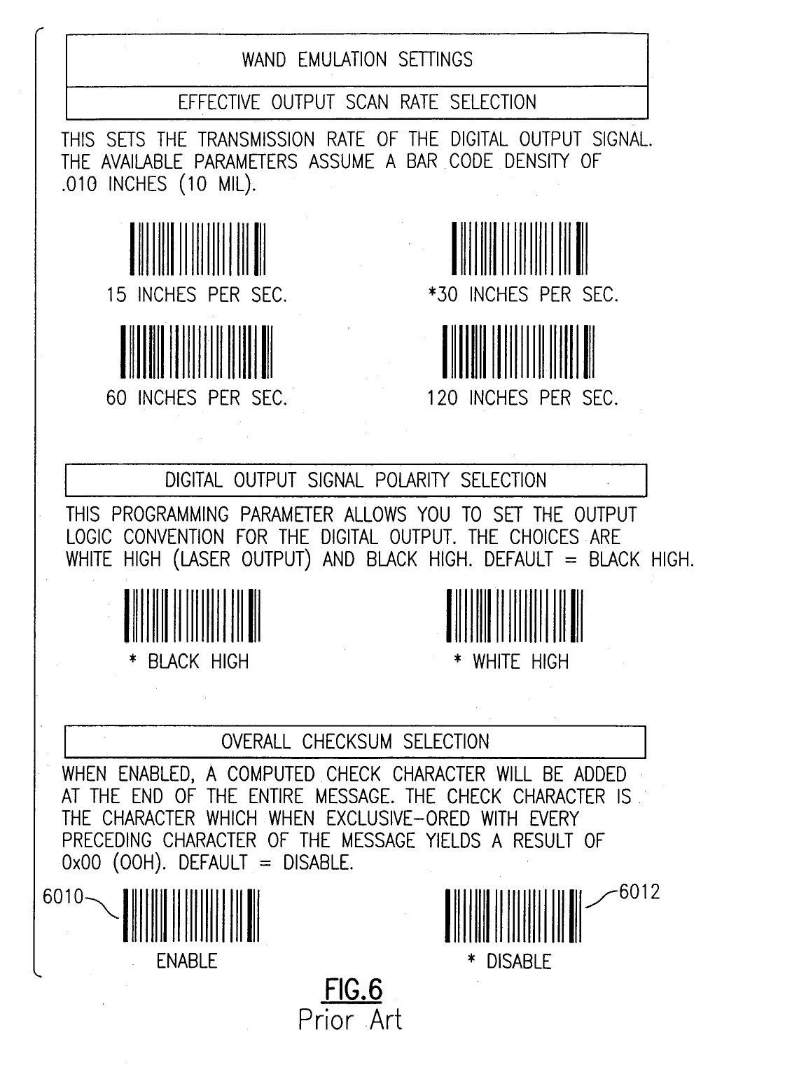

The invention is better understood with reference to the scan map of FIG. 7 corresponding to a prior art reader, which in the embodiment shown includes an image sensor 32, an imaging optics 40 and a housing 11. Scan map 700, in which a field of view of image sensor 32 is delimited by boundary lines 702 indicates that a field of view of image sensor 32 increases as distance of reader 5 from a target increases. “Field of view” generally refers to the image field presently being imaged on to an active surface of image sensor 32. Referring to further aspects of scan map 700, symbol 706 represents a symbol at a contact or near contact reader to target distance, d1. Symbol 708 represents a symbol at a medium reader to target distance, d2. While symbols 710, 712, and 714 represent decodable symbols at long range reader-to-target distances, d3. At contact or near contact reader to target distances, generally only a single symbol is typically within a field of view of image sensor 32. At longer reader distances, d3, several symbols may be within a field of view of image sensor 32. Referring to the reprogramming menu sheet of FIG. 6 it is seen that at longer reader-to-target distances (e.g. 2 feet) that more than one symbol can be located in a field of view of reader 5. If a symbol other than the symbol intended to be decoded is decoded, the reader 5 will be reprogrammed in a way that is undesired. In another application involving a multiple symbol scene (an ID card, a package) the decoding of a symbol other than the symbol intended to be decoded will result in the wrong decoded out message being output by reader 5.

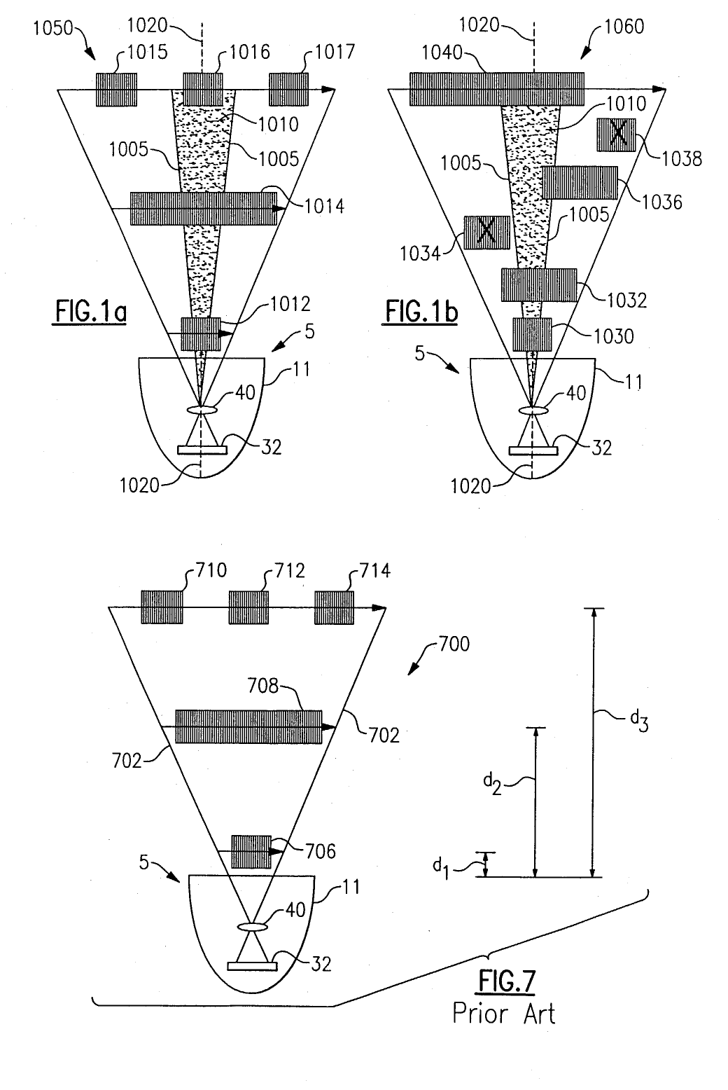

The present invention is described generally with reference to the scan maps of FIGS. 1a and 1b. A reader according to the invention is configured so that symbols that are not at least partly within a valid zone 1010 delimited by boundary lines 1005, e.g. symbols 1034 and 1038 are not subjected to decoding. The present invention is based upon the presumption that when a user aims a reader 5, the user generally tries to center the reader laterally so that a horizontal centerline 1020 of reader 5 (which may be imaginary or a visible marking) is aligned with a symbol which a user wishes to decode. Referring to FIG. 1a, centerline 1020 is aligned with symbols 1012, 1014, and 1016. According to the invention, therefore, symbol representations located in a slice image frame are disregarded if they do not include image data corresponding to predetermined valid zone of pixel positions, which typically comprise pixel positions at a center of an image sensor array. The configuring of a reader described is based on the assumption that symbols located at lateral edges of a field of view (e.g. symbols 1015, 1017) are within a field of view of a reader not because a user intended to move a reader into such position that the symbol is located toward an edge of a field of view, but because the edge-located symbol is proximate a more centrally located symbol, which the user intended to decode. It will then be seen that the term “valid zone” herein is used to refer to both a subset of an image field subjected to imaging and a subset of the image data representing that image field.

A reader according to the invention may be programmed so that symbols are subjected to decoding if and only if they are at least partially encroached upon a valid zone 1010. As seen in the scan maps of FIGS. 1a and 1b valid zone 1010, which comprises a subset of the filed of view of reader 5, is advantageously defined toward a center of a field of view. During processing of image data, to be discussed in greater detail herein, image data captured by reader is evaluated to determine whether symbol image data corresponds to a valid zone 1010. In one embodiment, a reader launches a decode algorithm only if the reader determines that a symbol is within a valid zone. Thus, in one embodiment, referring to scan maps 1050 and 1060, symbols 1012, 1014, 1016, 1030, 1032, 1036, and 1040 are subjected to decoding because at least a part of each of the above symbols falls within valid zone 1010. Symbols 1034 and 1038, in one embodiment, although within a field of view of reader 5, will not be subjected to decoding because they fall completely outside of valid zone 1010.

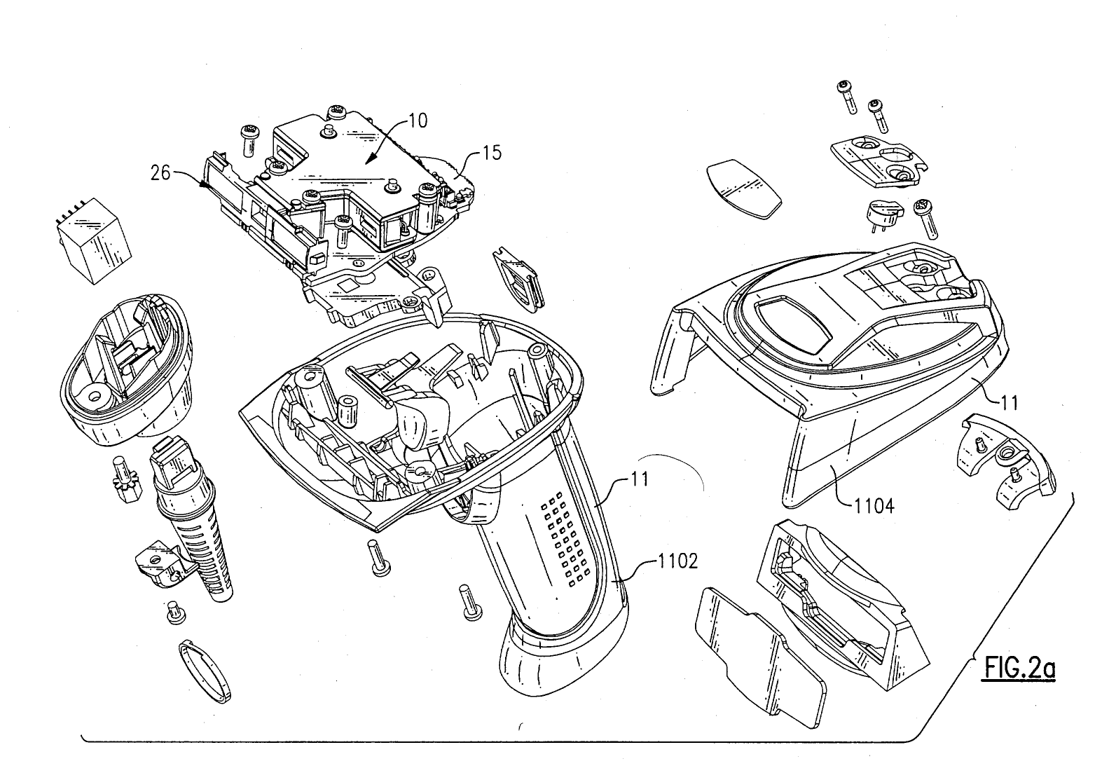

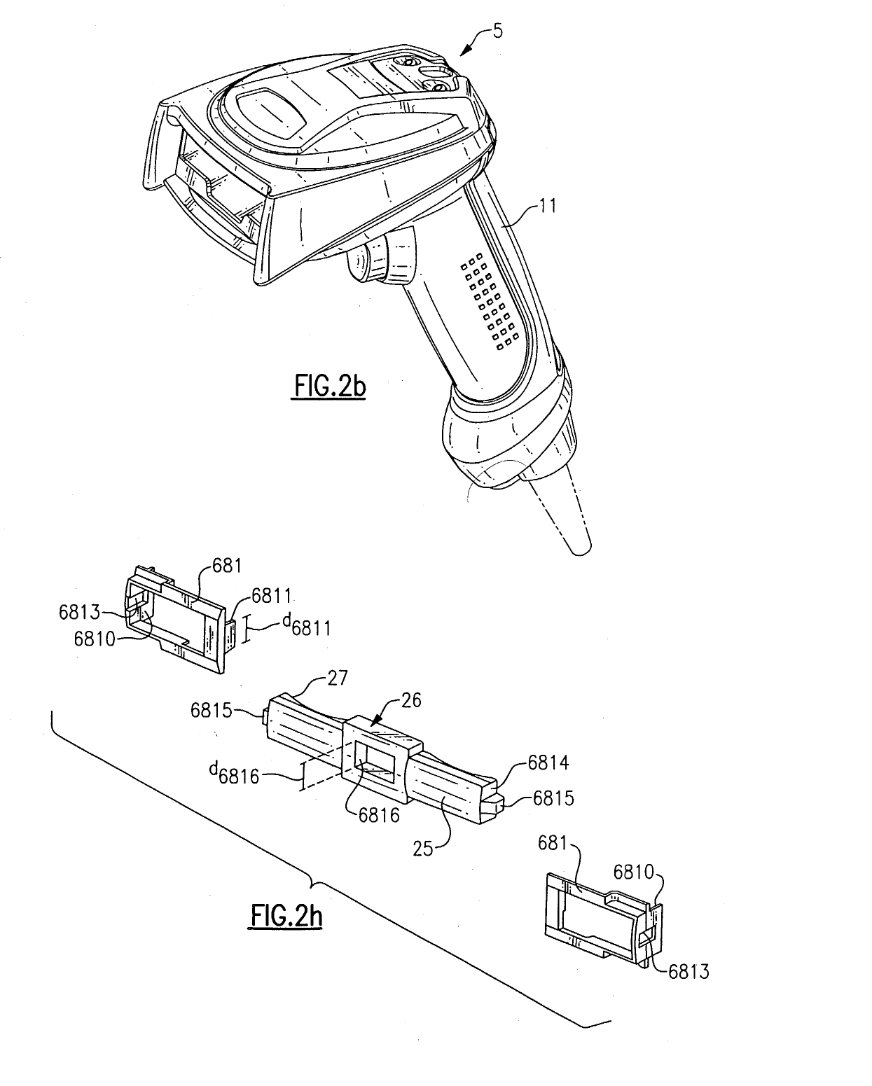

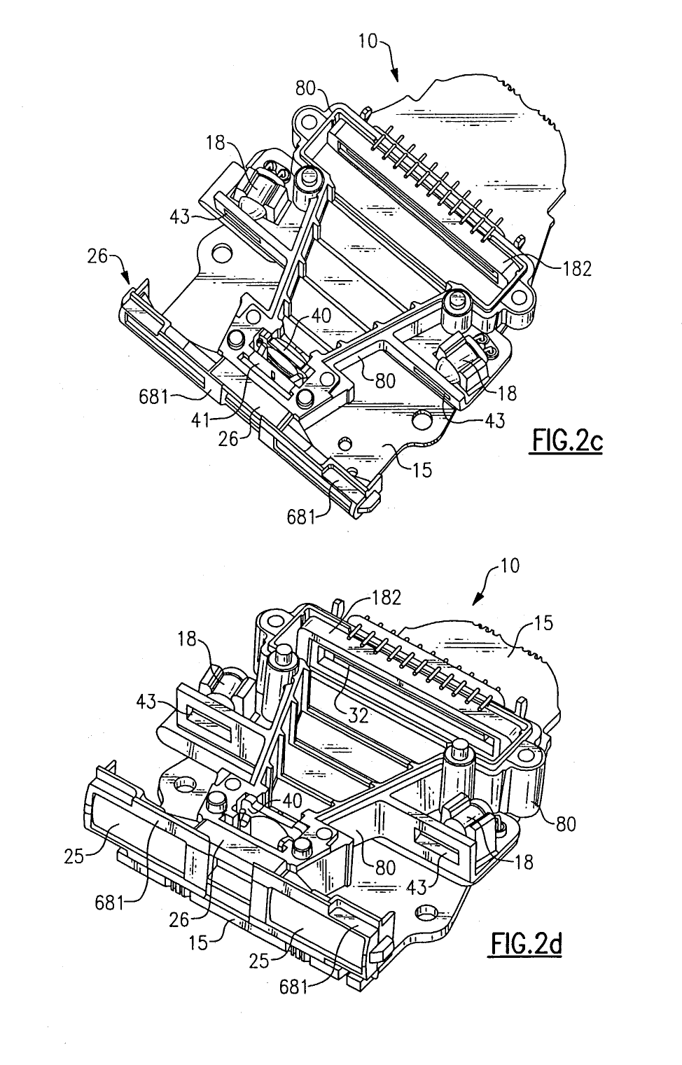

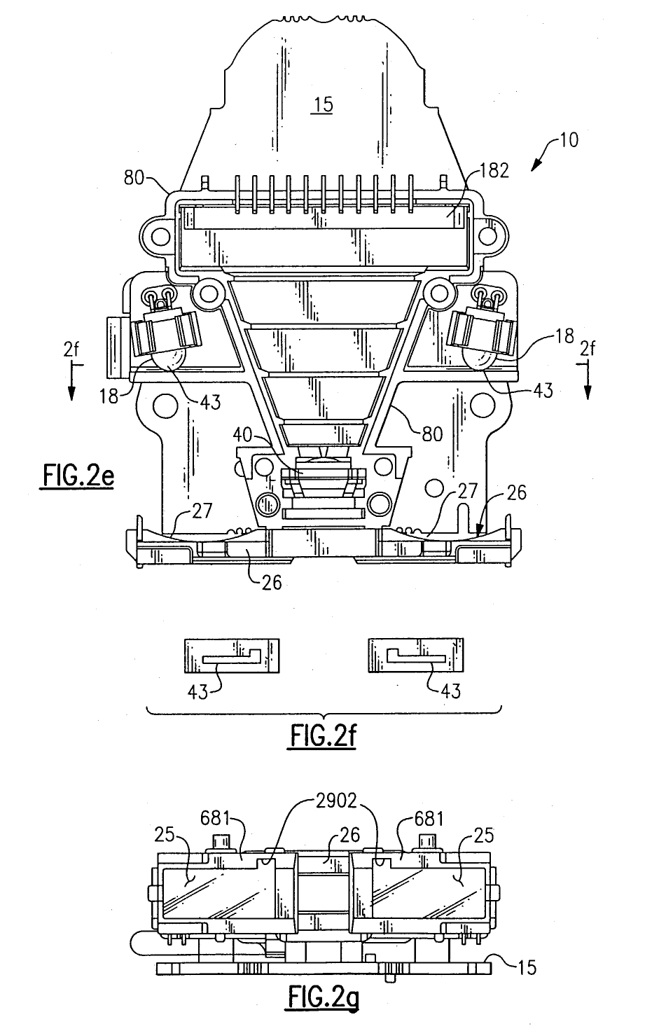

Various aspects of optical readers in which the invention may be incorporated are described in FIGS. 2a-2g. FIG. 2a shows an exploded perspective view of an optical reader in which the invention may be incorporated. Reader 5 includes a housing 11 having a handle 1102 and a hood 1104, an imaging module 10, a printed circuit board 15 and various other features which are described in greater in greater detail in application Attorney Docket No. 283-354.01 filed on the same day as the present invention entitled “Housing for Optical Reader”, and incorporated herein by reference. A complete assembled optical reader is shown in FIG. 2b.

Further aspects of an imaging module 10 which may be incorporated in reader 5 are described with reference to FIGS. 2c-2e. Imaging module 10 includes a support frame 80, a linear multiple pixel image sensor 32, and an aiming/illumination system including aiming/illumination LEDs 18, slit apertures 43, an optical member 26 including a cylindrical lens surface 25 formed on light exit surfaces thereof and a negative lens diffuser 27 disposed on light entry surfaces thereof. Imaging module 10 is similar to the imaging module described in U.S. Pat. No. 6,119,939 issued Sep. 19, 2000 entitled “Optical Assembly for Barcode Scanner”, U.S. Pat. No. 6,164,544 issued Dec. 26, 2000 entitled “Adjustable Illumination System for a Barcode Scanner”, and U.S. Pat. No. 6,65,388 issued Apr. 14, 2001 entitled “Image Sensor Mounting System” all incorporated by reference herein. Imaging module 10 differs from the imaging modules of the above application in that imaging module 10 includes one, not two LEDs per LED bank, diffusers 27 are provided by negative lens diffuser, and optical member 25 carrier sharpening baffles 681. Sharpening baffles 681, which are fitted over member 26 comprises opaque material and includes sharply defined edges. Sharpening baffles 681 provide an aiming line sharpening function described in application Ser. No. 10/093,140 entitled “Optical Reader Aiming Assembly Comprising Aperture” filed Mar. 7, 2002, incorporated herein by reference, particularly with reference to element 681 (shown in FIGS. 2m, 6m, and 1m of the above mentioned application Ser. No. 10/093,140 as best seen in the exploded assembly view of FIG. 2h. Baffles 681 may comprise opaque material and may comprise such material as black polycarbonate. Baffles 681 may be made to be snap-fitted or otherwise friction fitted onto optical member 26. In the embodiment best seen in FIG. 2h, baffles 681 include resilient sidewalls 6810 and 6811. Sidewall 6810 includes aperture 6813 for installing baffle 681 on member 26, sidewall 6810 engages wall 6814 such that notch 6815 is fitted through aperture 6813, and sidewall engages wall 6816 of member. Notch 6815 and aperture 6813 are complementary shaped and sized to aid in the proper alignment of baffle 681 on member 26. Wall 6811 and wall 6816 are likewise complimentary sized (d6811 and d6816) to aid in the proper aligning of baffle 681 on member 26.

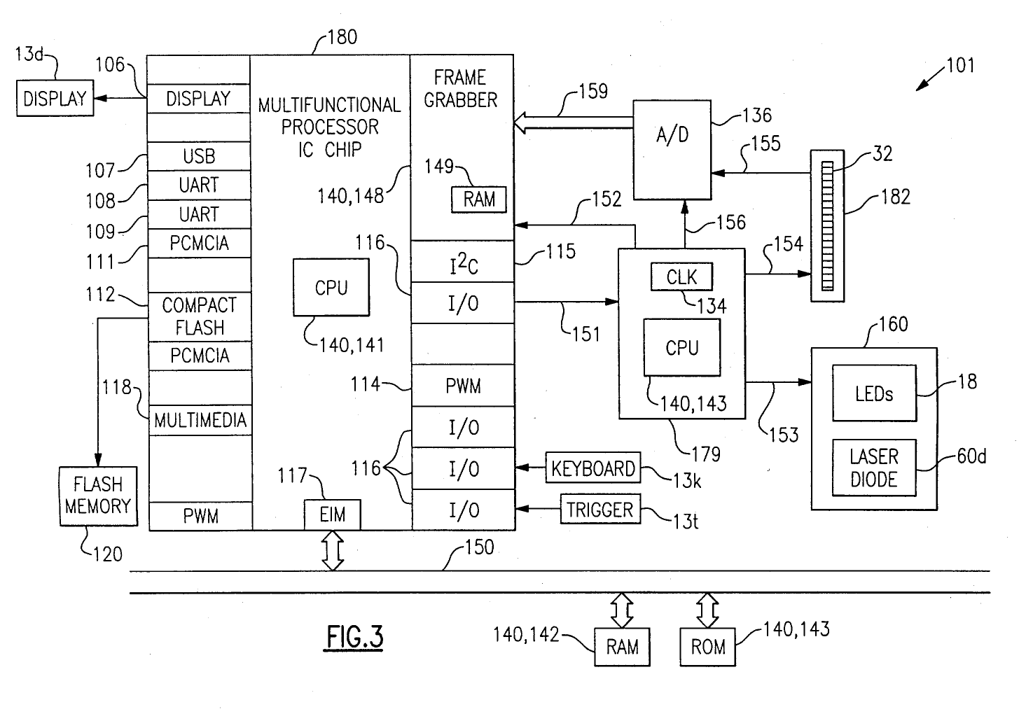

Referring to further aspects of reader 5, it is seen that in the embodiment of FIG. 2c imaging module 10 is carried by printed circuit board 15. Circuit board 15 may carry numerous components of an electrical circuit for controlling operation of reader 5. Aspects of an electrical circuit for controlling reader 5 are described with reference to the block diagram of FIG. 3.

In the specific embodiment of FIG. 3, electrical circuit 101 includes a control circuit 140 comprising CPU 141, CPU 143, system RAM 142 system ROM 143 and frame grabber block 148. Electrical circuit 101 further includes an image sensor 32 typically provided by a photosensitive array and an illumination block 160.

In the embodiment shown in FIG. 3, CPU 141 and frame grabber block 148 are incorporated in a multifunctional IC chip 180 which in addition to including CPU 141 includes numerous other integrated hardware components. Namely, multifunctional IC chip 180 may include a display control block 106, several general purpose I/O ports 116, several interface blocks such as a USB circuit block 107 and UART block 108 for facilitating RS 232 communications, a UART block 109 for facilitating infrared communications (including communications according to standards promulgated by the INFRARED DATA ASSOCIATION [IDA], a trade association defining infrared standards, and a pulse width modulation (PWM) output block 114. Multifunctional processor IC chip 180 can also have other interfaces such as a PCMCIA interface 111, a compact flash interface 112, and a multimedia interface 118. If reader 5 includes a display 13d, display 13d may be in communication with chip 180 via display interface 106. Trigger 13t and keypad 13k (if included on reader 5) may be in communication with chip 180 via general purpose I/O interface 116. Multifunctional processor IC chip 180 may be one of an available type of multifunctional IC processor chips which are presently available such as a Dragonball MX1IC IC processor chip available from Motorola, an Anaconda IC processor chip available from Motorola, a DSC IC chip of the type available from Texas Instruments, an O-MAP IC chip available from Texas Instruments or a multifunction IC Processor chip of a variety known as Clarity SOCs available from Sound Vision, Inc.

Frame grabber block 148 is specifically adapted collection of hardware elements programmed to carry out, at video rates or higher, the process of receiving digitized image data from image sensor chip 182 and writing digitized image data to system RAM 142 which in the embodiment shown is provided on a discreet IC chip. Frame grabber block 148 includes hardware elements preconfigured to facilitate image frame capture. Frame grabber block 148 can be programmed by a user to capture images according to a user's system design requirements. Programming options for programming frame grabber block 148 include options enabling block 148 to be customized to facilitate frame capture that varies in accordance with image sensor characteristics such as image sensor resolution, clockout rating, and fabrication technology (e.g. CCD, CMOS, CID), dimension (1D or 2D) and color (monochrome or color).

Referring to further aspects of electrical circuit 101, circuit 101 includes a system bus 150. Bus 150 may be in communication with CPU 141 via a memory interface such as EIM interface 117 of IC chip 180. System RAM 142 and system ROM 143 are also connected to bus 150 and in communication with CPU 141 via bus 150. In the embodiment shown, RAM 142 and ROM 143 are provided by discreet IC chips. System RAM 142 and system ROM 143 could also be incorporated into processor chip 180.

In addition to having system RAM 142, sometimes referred to as “working” RAM, electrical circuit 101 may include one or more long term storage devices. Electrical circuit 101 can include for example a “flash” memory device 120. Several standardized formats are available for such flash memory devices including: “Multimedia” (MMC), “Smart Media,” “Compact Flash,” and “Memory Stick.” Flash memory devices are conveniently available in card structures which can be interfaced to CPU 141 via an appropriate “slot” electromechanical interface in communication with IC chip 180. Flash memory devices are particularly useful when reader 5 must archive numerous frames of image data. Electrical circuit 101 can also include other types of long term storage such as a hard drive which may be interfaced to bus 150 or to an appropriate I/O interface of processor IC chip 180.

Referring to further aspects of electrical circuit 101, electrical circuit 101 may comprise a low cost 1D CCD image sensor 32 disposed on an IC chip 182. Image sensor 32 of FIG. 3b may be provided for example in a Toshiba Model TCD 1304 AP linear image sensor. Image sensor 32 can comprise e.g. a 1×N (e.g. 1×3500) array of picture elements (pixels), or an M×N, N>>M array (e.g. 5×2500, 20×2000, 2×3000) of picture elements. The imaging assembly comprising LEDs 18 optics 40 and image sensor 32 can be replaced by a laser scanning imaging assembly including a laser diode light source, directed at a moving reflective element which scans the laser light across a target substrate, and a single photodetector which sensors the laser light reflected from the target substrate.

Control circuit 140 of circuit 101 is partially incorporated in a multifunctional processor IC chip 180 including CPU 141 and a frame grabber block 148. Control circuit 140 of circuit 101 further includes system RAM 142, system ROM 143 and supplementary central processor unit (CPU) 141, integrated on processor IC chip 179. System RAM 142 and system RAM 143 are in communication with EIM interface 117 of IC chip 180 via bus 150.

Processor IC chip 179 provides control and timing operations. Processor IC chip 179, in general, sends synchronization signals and digital clocking signals to IC chip 180, and sends digital clocking signals to A/D 136 and 1D image sensor chip 182 including image sensor 32. Processor IC chip 179 of circuit 101 may be a relatively low power processor IC chip such as an 8 BIT Cyprus PSOC CY8C26233-24PVI Microcontroller processor IC chip.

Aspects of the operation of IC chip 179 during the course of capturing one-dimensional slice image data will now be described in detail. When trigger 13t is pulled, CPU 141 transmits an image capture enable instruction over communication line 151. In response to receipt of an image capture enable instruction received from chip 180, processor IC chip 179 performs a variety of operations. Via communication line 152, processor IC chip 179 may send synchronization signals, such as “start of scan,” “data valid window,” and “data acquisition clock” signals to frame grabber block 148. Processor IC chip 179 may also send timing signals and digital clocking signals (e.g. master clock, integration clear gate, and shift gate pulse) to ID image sensor chip 182 including ID image sensor 32. Processor IC chip 179 typically also transmits a master clock signal to A/D block 136. Referring to further aspects of IC chip 180 of circuit 101, CPU 141 of chip 180, may also send e.g. gain setting, exposure setting, and timing initialization signals via line 151 to IC chip 179. Communication between IC chip 180 and IC chip 179 may be made via an SPI interface or I/O interface 116 of chip 180 and chip 179.

Processor IC chip 179 may be replaced by a programmable logic circuit, e.g. a PLD, CPLD, or an FPGA. IC chip 179 could also be replaced by an ASIC. Referring to further aspects of electrical circuit 101, analog voltage levels transmitted by image sensor 32 on line 155 are converted into gray scale pixel values by A/D converter 136 and then transmitted via line 159 to frame grabber block 148. Circuit 101 could also include a what may be referred to as an analog digitizer which processes an analog signal generated by image sensor 32 to generate a two-state output signal that changes state in accordance with light-to-dark and dark-to-light transitions of the image sensor analog output signal.

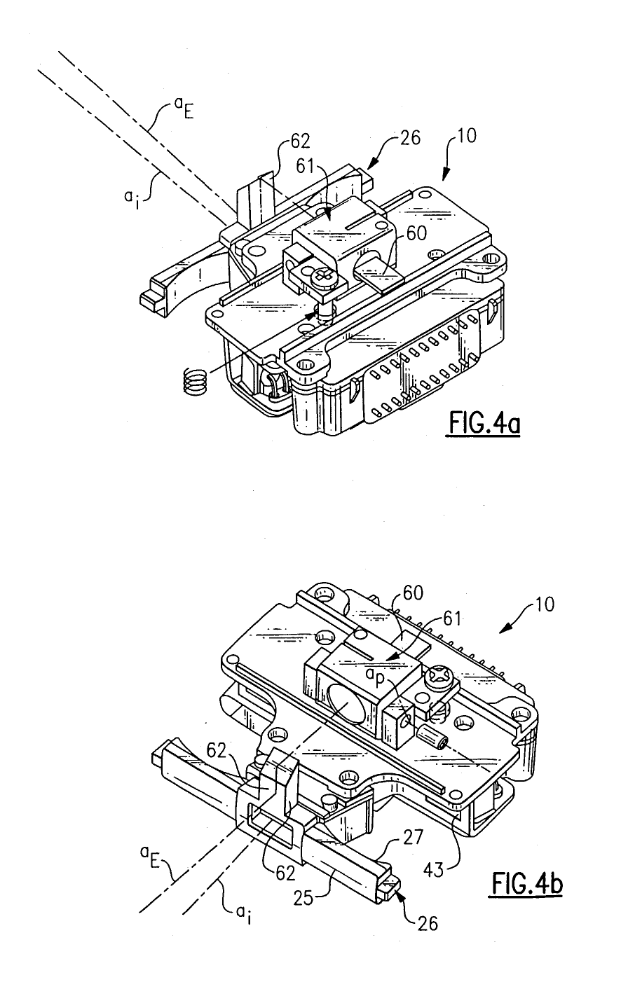

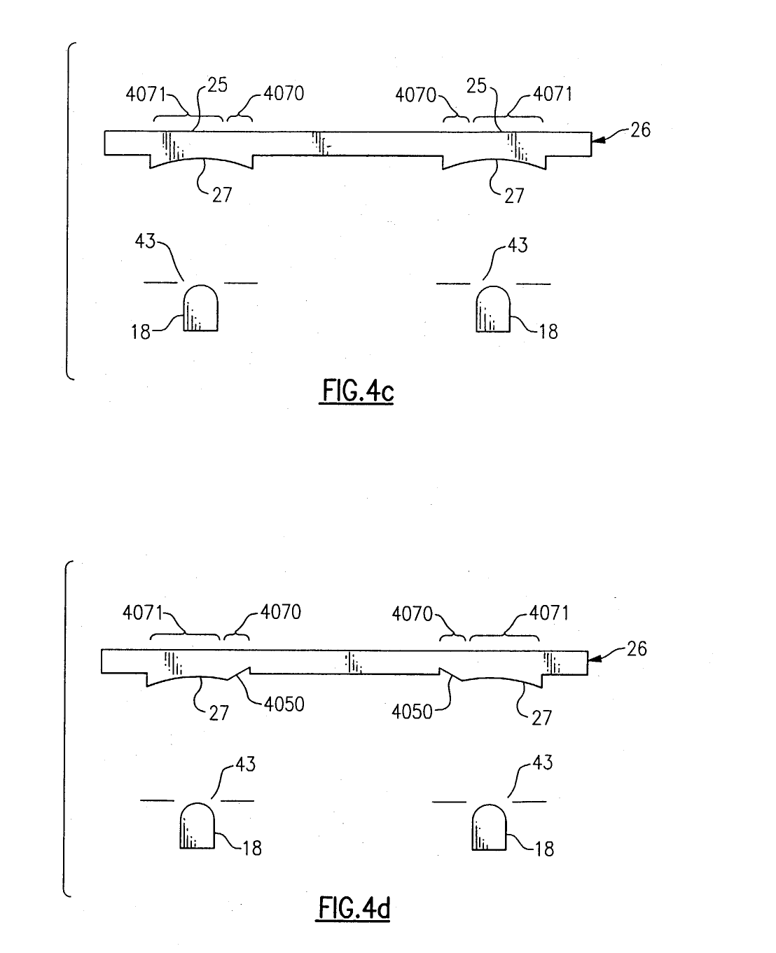

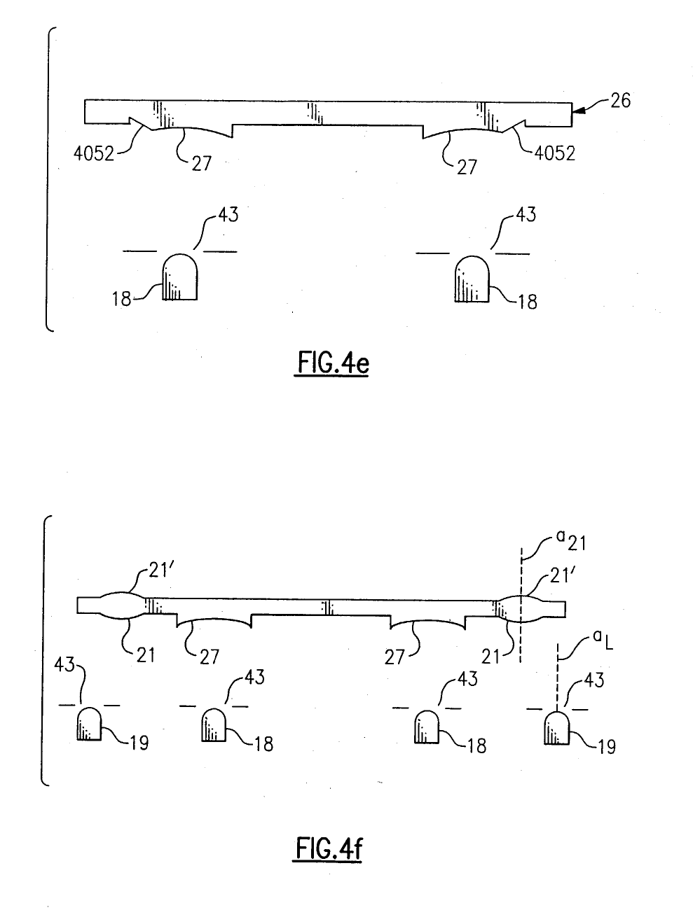

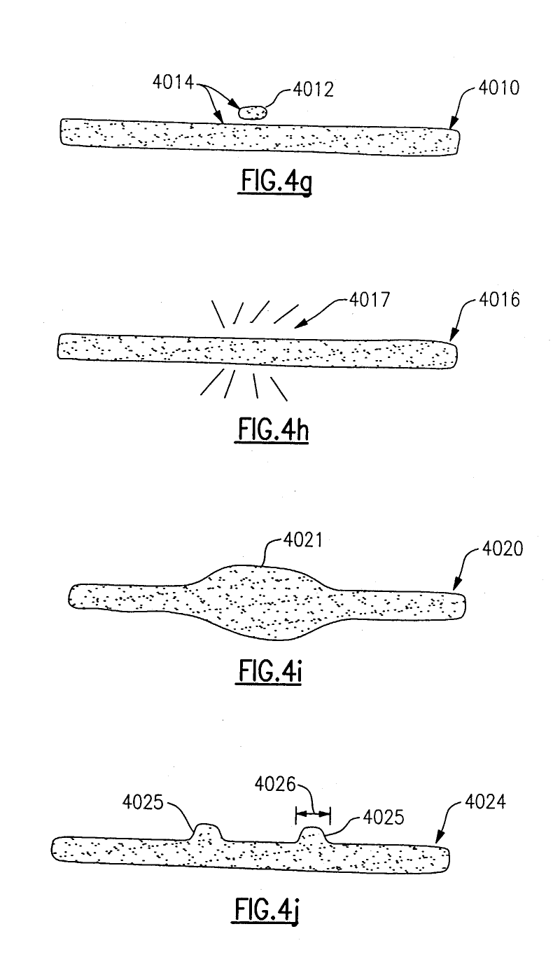

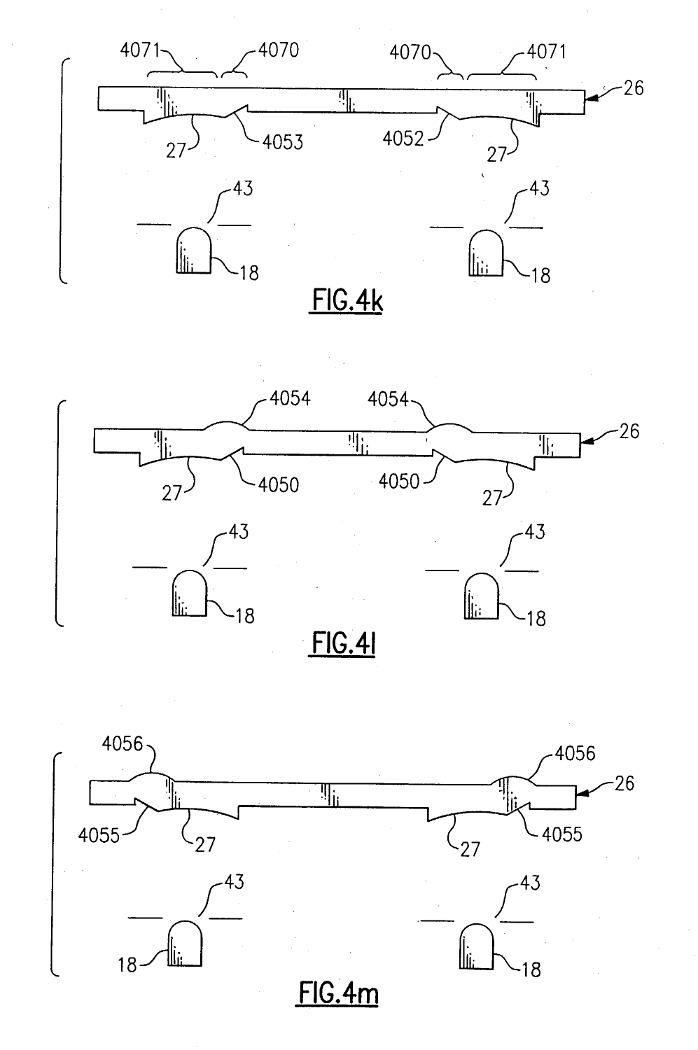

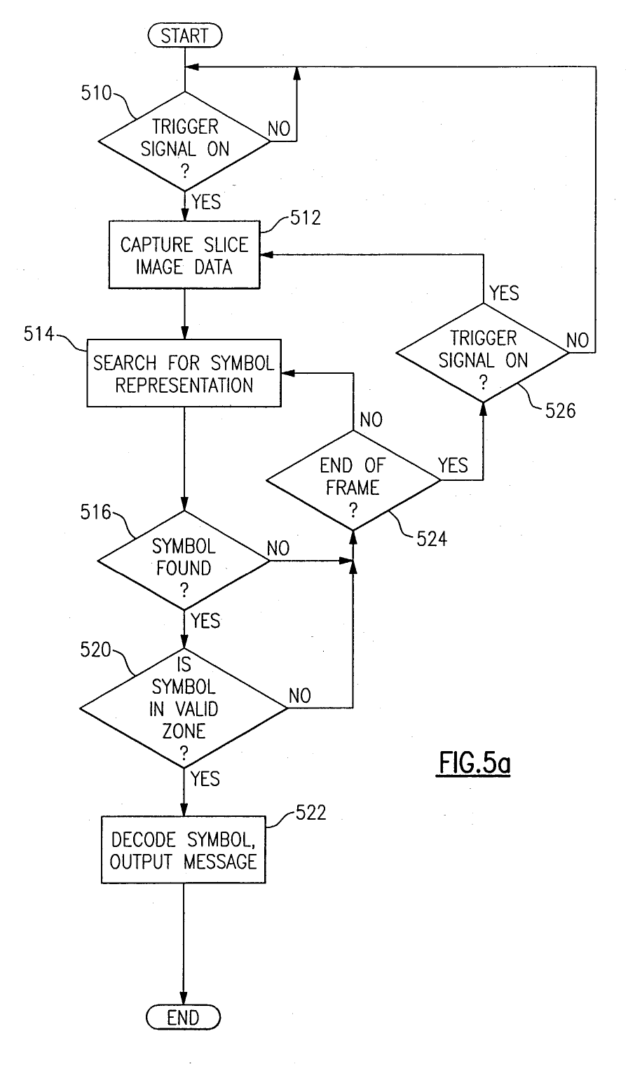

Processor IC chip 179 also controls illumination block 160. Illumination block 160 of reader 5 typically includes a single bank of LEDs 18 which simultaneously illuminates a target area and projects an aiming pattern facilitating aligning of the reader with a target indicia. Illumination block 160 may also include elements for producing a lateral center-indicating aiming pattern such as a laser diode 60d of laser diode assembly 60, to be described in greater detail here with reference to FIGS. 4a and 4b. LEDs 18 of ID imaging module can be pulsed so as to reduce energy consumption by LEDs 18. Laser diode 60d can be controlled so as to be selectively turned on intermediate of frame exposure periods in the manner described with reference to application Ser. No. 10/252,484 filed Sep. 23, 2002 entitled “Long Range Image Reader”, incorporated herein by reference.

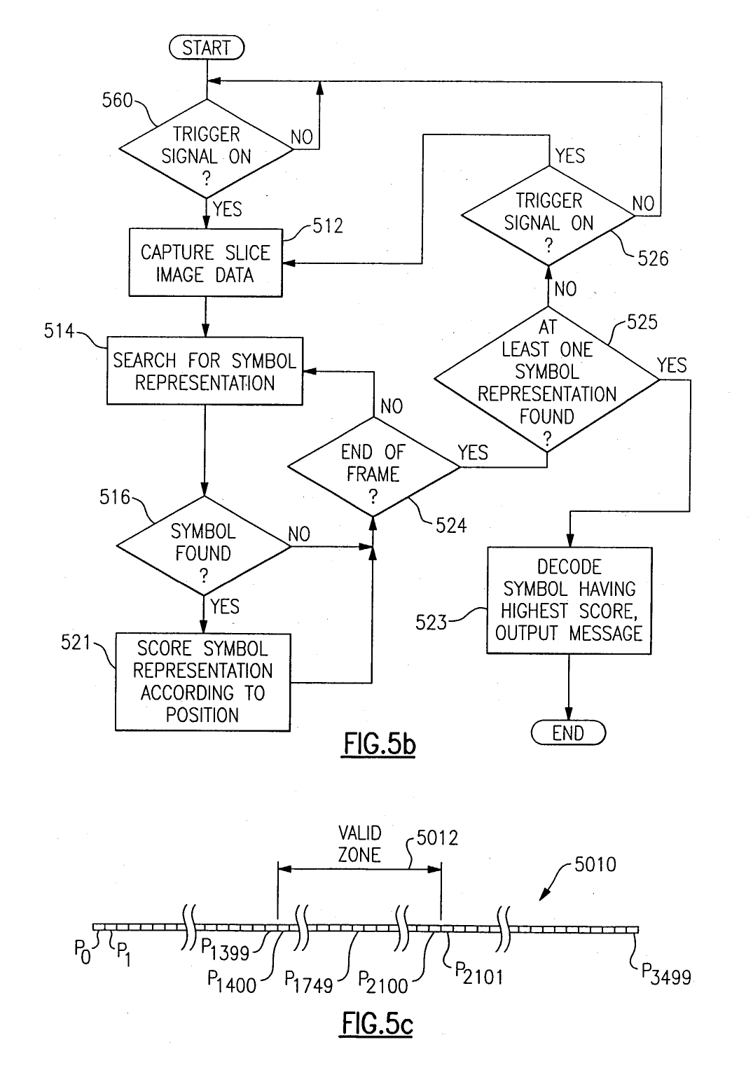

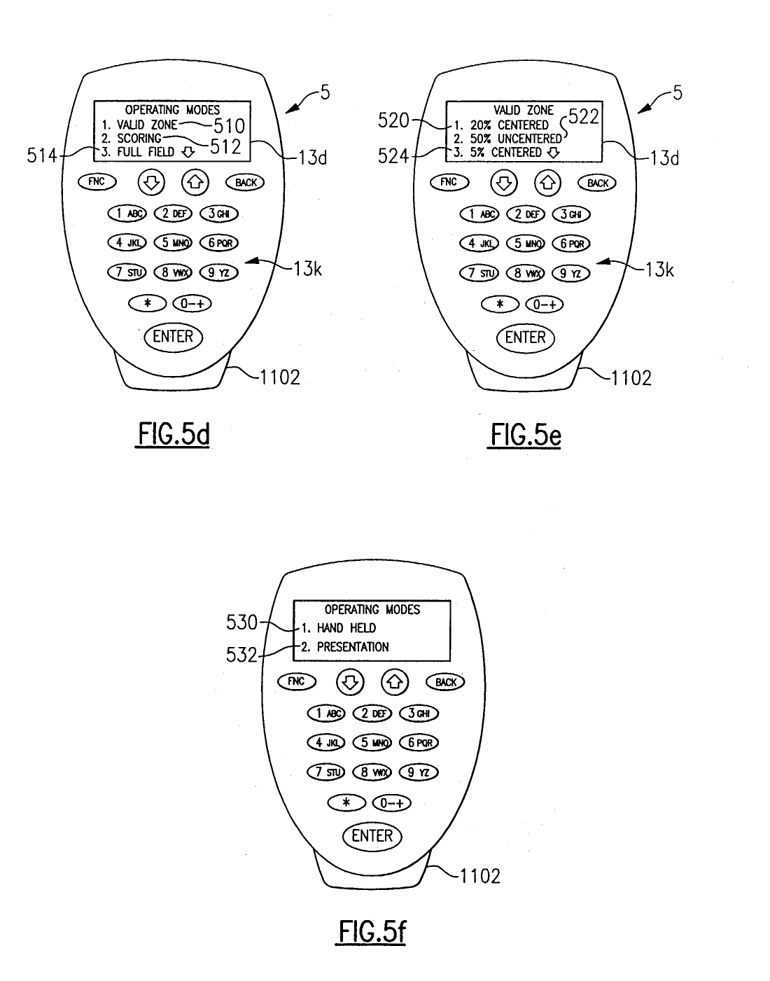

Referring now to more particular aspects of the invention, operation of the invention in one embodiment is described with reference to the flow diagram of FIGS. 5a and 5b.

At block 510 control circuit 140 of reader 5 waits for a trigger signal to a switch to an ON state. The ON state of the trigger signal may be actuated by manual actuation of trigger 13t. A trigger signal may also be driven into ON state automatically on the sensing of a predetermined condition. A method for automatic driving of a trigger signal into an ON state is described in copending application Ser. No. 09/432,282 filed Nov. 2, 1999 entitled “Indicia Sensor System for Optical Reader” incorporated herein by reference.

At block 512 control circuit 140 captures a slice frame of image data. Where image sensor 32 is a 1×N pixel array, the capturing of a slice frame of image data referred to in block 512 may refer to the process whereby control circuit 140 stores in memory 142 a 1×N image map corresponding to an image focused on an active surface of image sensor 32. The image map captured at block 512, where image sensor 32 is an M×N, N>>M pixel image sensor may be an M×N image map. The pixel values of the image map may include multibit (e.g. 8, 16) grey scale indicating or color indicating values or binary 1 BIT (0 or 1, i.e. dark or light) values. The “capturing” step at block 512 may refer to the two step process of storing a grey scale image map and converting the grey scale image map into a binarized image, or bit map. At block 512 control circuit 140 can also capture slice image data, for example, by storing “timercount” data (data indicating distance between sensor bars and spaces) into memory 142 based on image signals generated by images sensor 32 or by a laser scan engine imaging assembly, as described herein.

At block 514 control circuit 140 searches for a decodable symbol representation in the captured slice image data captured at block 512. Decodable 1D symbols representations may be included in slice frame of image data. Control circuit 140 may search for decodable 1D symbol representations in captured image data in a variety of different ways, for example, at block 514 control circuit 140 may search for, and identify “quiet zones”. A quiet zone in image data is a relatively large number of light pixels bordering a transition region characterizing by alternating small clusters of dark pixels and light pixels. Code 39 is an example of a 1D bar code symbol which may be located by a process of searching for quiet zones. In addition to or in place of searching for quiet zones at block 514, control circuit 140 at block 514 may search for symbol stop and start patterns. Stop and start patterns are unique patterns of dark and light spaces which indicate there being in a captured image a symbol representation of a certain type. RSS is an example of a bar code symbology type which may be located by a process of searching for stop and start patterns.

If control circuit 140 at block 516 determines that a symbol representation has been located, control circuit 140 at block 520 determines if the symbol representation is within a “valid zone.” When a symbol representation is located at block 514, control circuit 140 normally determines the position of the symbol representation in the captured slice image. For example, if the captured image data comprises an image map comprising a plurality of pixel values, control circuit at block 514 will have stored in memory 142 the starting position pixel location and stop position pixel location of the symbol representation located at block 514. In determining whether the symbol representation is within a valid zone at block 520 control circuit 140 may compare the symbol start and stop positions to predetermine “valid zone” position data. The predetermined valid zone position data may be for example position data corresponding to the middle 20 percent of pixel positions of an image map. Another percentage value may be selected such as 50 percent centered pixel positions or 5 percent of the centered pixel positions. The valid zone position data may be adjusted in response to user input as will be described later herein. Referring to the image map of FIG. 5c the valid zone position data may be data corresponding to the middle 20percent of pixel positions of a 1×3500 pixel array, or pixel positions P₁₄₀₀ to P₂₁₀₀ of the array. If at block 520 control circuit 140 determines that one of a symbol representation's start or stop positions is a position of the valid zone position data, control circuit 140 proceeds to block 522.

At block 522, control circuit 140 launches at least one decoding algorithm corresponding to the type of symbol representation determined to be present at block 514. The symbol locating information yielded at block 514 may have indicated that one specific symbol type is present, in which case control circuit 140 at block 522 launches a decoding algorithm corresponding to that specific symbol type. The symbol locating information yielded at block 514 may also indicate that one of P possible symbol types is present, in which case control circuit may launch P different decoding algorithms in succession (each corresponding to a different ones of the possible symbol types) until a bar code symbol is decoded. Aspects of decoding algorithms for decoding various types of symbols are known and are publicly available, AIM, Inc., The Association for Automatic Identification and Data Capture Technologies, publishes bar code symbology standards and notices. Various bar code standards are available from the AIM, Inc. website, www.aimglobal.org. The symbol decoded at block 522 in addition to being a bar code may be e.g. a decodable character or a fingerprint.

If control circuit 140 successfully decodes a symbol at block 522 control circuit 140 outputs at block 522 a decoded out message corresponding to the symbol. The decoded output message may be output e.g. to a specific memory location of memory 142 and/or to a display 13d of reader 5, or to an external device such as a host computer. According to the specific process indicated by the flow diagram of FIG. 5a only one decodable symbol is output per slice frame of image data captured. However, reader 5 could also be configured, possibly in response to a user reprogramming command, to output more than one decoded out message per captured frame.

Referring to additional processing blocks included in FIG. 5a, the processing loop including SYMBOL FOUND block 516, END OF FRAME block 524 and SEARCH FOR SYMBOL REPRESENTATION block 514 indicates that the search for symbol representations in the captured slice image data continues until the pixel value information read from the frame thus far indicates that the captured slice frame includes no further symbol representations. The search for symbol representations indicated at block 514 may include reading of pixel values of a captured slice image map from-left-to-right across a captured image map wherein each pixel value corresponds to a particular pixel position, from right to left across a captured image map, from center-outward, on a sampled pixel-value basis, or according to a predetermined or dynamically determined pattern that is a combination of more than one of the above mentioned search patterns.

Referring to still further processing blocks of the flow diagram of FIG. 5a, the processing path indicated by END OF FRAME block 524 and CAPTURE SLICE IMAGE DATA block 512 indicates that reader 5 may be configured to repeatedly and automatically capture slice image data for subjecting to symbol searching, as long as a trigger signal remains in an ON state.

One alternative embodiment of the invention is described with reference to the flow diagram of FIG. 5b. According to the processing indicated by the flow diagram of FIG. 5b, the SYMBOL IN VALID ZONE block 520 is replaced by symbol representation position scoring block 521 in which control circuit 140 scores each located symbol representation with a scoring value depending on the symbol representation's position in the captured slice image.

Referring to the method indicated by the flow diagram of FIG. 5b in greater detail, control circuit 140 in executing the steps indicated by blocks 514, 516, 521, and 524 continuously searches for symbol representations in the captured slice image data, and issues to each located symbol representation a position score that depends on the position of the symbol representation in the captured image. According to the invention, centrally located symbol representations are normally issued higher scores than symbol representations located toward an edge of a captured image. Control circuit 140 exits the loop of blocks 514, 516, 521, and 524 when at block 524 control circuit 140 determines that no further symbol representations are included in the captured slice image. If control circuit 140 at block 524 determines that at least one symbol representation has been found, control circuit 140 proceeds to block 523 to decode the symbol representation having the highest position score. Decoding and output proceeds in the manner described previously relative to decode and output block 522 indicated in the flow diagram of FIG. 5u.

The flow diagrams of FIGS. 5a and 5b produce different results under certain operational scenarios. According the flow diagram of FIG. 5a, symbol representations at edges of an image map (and having no part in a valid zone) such as symbol 1034 or symbol 1038 of FIG. 1b are not subjected to decoding. According to the flow diagram of FIG. 5b, symbol representations at an edge of an image map are subjected to decoding unless the captured slice image also includes another symbol representation that has been issued a higher positional score indicating a more central image position. A reader operating according to either of the flow diagrams of FIGS. 5a and 5b, broadly stated, finds a symbol representation image position and responsively utilizes the position data to determine whether to launch a decode algorithm to decode the symbol representation. Control circuit 140 operating either according to the method of FIGS. 5a and 5b includes a decode launch circuit which processes symbol representation position data to determine whether a decode algorithm should be launched.

Reader 5 can be manufactured so that the reader 5 is made to operate in accordance with the invention as a default operating mode; that is, when the reader is sold and made available to a customer. Reader 5 can also be made so that reader 5 is made to operate in accordance with a method according to the invention (wherein a decode launch circuit processes symbol position data to determine whether to launch a decode algorithm) by way of a user input command input to a user. The reprogramming of reader 5 so that reader 5 operates in accordance with the invention can be accomplished in a variety of ways. For example, reader 5 can be configured so that reading by reader 5 of a specialized reprogramming symbol as shown by example in FIG. 6 results in reader 5 operating in accordance with the invention. Reader 5 may also have at least one of a keyboard 13k, which may be of a physical key variety and/or a touch pad and may be configured so that actuation of a certain key commences a position dependant decode launch operating mode as described herein. Any suitable menu interface may be used for any menu function described herein, including a voice menu. Further, selection of an operating mode may be aided with incorporation of a graphical user interface including a manually movable pointer. Reader 5 may display on a display 13d of reader 5 a menu option indicating to a user that the position dependent decode launch operating method described herein is available to a user. For example, as shown by the example of FIG. 5d, reader 5 may display on display 13d the text VALID ZONE MODE 510 or an ICON in a list of menu options. Selecting of the VALID ZONE MODE text 510 or ICON (by touching the option in the case of a touch screen, or corresponding key, of keyboard 13k, or by pointing and clicking using a pointer, etc.) causes reader 5 to operate in accordance with the invention. Reader 5 can be made so that processing options that are within the invention are also user-selectable. For example, reader 5 may display on display a list of menu options 510, 512, and 514 allowing a user to select between the operating mode described with reference to the flow diagram of FIG. 5a (by selecting option 510) and the operating mode described with reference to the flow diagram of FIG. 5b (option 512). Selecting Option 514 (FULL FIELD) in the example of FIG. 5d switches operation of reader into a mode wherein the first located symbol in a captured image is decoded irrespective of its position. Reader 5 can be configured so that the width and/or position of valid zone 1010, 5012 is user selectable via a menu interface, e.g. a menu interface as shown in FIG. 6, or a menu interface as shown in FIG. 5e. Referring to reader 5 of FIG. 5d, selection of option 520 results in a valid zone being defined at 20% of a field of view of reader 5 centered. Selection of option 522 results in a valid zone being defined at 50% of a filed of view of reader 5, uncentered, and selection of option 524 results in a valid zone being defined at 5% of a field of view of reader 5, centered.

Regarding FIG. 5f, reader 5, may be configured to have a user selectable “hand held” mode and a user selectable “presentation mode” which may be user selectable with use of a menu interface e.g. of the type shown in FIG. 5 or of the type shown in FIG. 5f. In a hand held mode, reader 5 is typically held in a hand and manually aimed by a user. In a presentation mode, reader 5 is typically positioned on a stand as described in application Ser. No. 09/432,282 filed Nov. 2, 1999 entitled “Indicia Sensor System for Optical Reader” incorporated herein by reference. If option 530 (hand held) is selected, reader 5 may operate in one of the modes according to the invention described with reference to FIG. 5a or FIG. 5b. If option 532 (presentations) is selected, reader 5 may operate in a “full field” mode in which reader 5 either decodes and outputs a first symbol representation located in captured image data or decodes and outputs all symbols located in a captured image data. Actuation of trigger 13t can be processed by circuit 140 as a selection of a hand held mode. The failure of trigger 13t to be actuated for a predetermined time can be processed as a selection of a presentation mode.

In another aspect of the invention, reader 5 may be configured to switch from a position dependent decode mode according to the invention and a full field mode, or vice versa, depending on a sensed condition. Control circuit 140 can be configured to automatically sense whether control circuit 140 is in a hand held mode or in a presentation mode. For example, a proximity sensor can be incorporated in a reader 5 and a proximity sensor triggering device can be incorporated at or about a presentation stand. If a signal generated by the proximity sensor is ON control circuit 140 determines that reader 5 is being-used in a presentation mode. If a signal generated by the proximity sensor is OFF control circuit 140 determines that reader 5 is being-used in a hand held mode. Reader 5 can also be configured to operate in a low power mode in which control circuit 140, without actuation of LEDs 18, captures frames of image data and evaluates the captured image data to determine whether reader 5 is in a hand held mode or a presentation mode. If the captured image data remains constant over the course of several frames for a predetermined time, control circuit 140 can determine that reader 5 is being used in a presentation mode. If the captured image data changes substantially over the course of several frames, control circuit 140 can determine that reader 5 is being used in hand held mode. If control circuit 140 determines that reader 5 is being used in a presentation mode, control circuit 140 may automatically commence operation in a mode according to the invention such as one of the modes described with reference to FIGS. 5a and 5b. If control circuit 140 determines that reader 5 is being used in hand held mode, reader 5 may automatically commence operation in a full field mode as described herein. Reader 5 may also commence operation in one of a position dependent decode mode or a full field mode automatically in response to a sensed reader-to-target distance signal. Control circuit 140 may be configured so that (a) at predetermined close reader-to-target distances, reader 5 operates in a full field mode and at (b) predetermined long range reader-to-target distances, reader 5 operated in a position-dependent decode launch mode. Methods for automatically generating a signal varying depending on reader-to-target distances are described in application Ser. No. 10/252,484, entitled “Long Range Optical Reader” filed Sep. 23, 2002, incorporated herein by reference.

The present invention, in one embodiment, deprioritizes decodable symbol representations located at edges of an image map. If a symbol representation is located at a center of an image map it likely will be subjected to decoding. If a symbol representation is located at an edge of an image map it may not be subjected to decoding. As described previously, a presumption underlying the invention is that a user using reader 5 intends to decode symbols at a center of an image field which are aligned with a horizontal centerline 1020 of reader 5, and may not wish to decode symbol representations found at edges of an image field. However, it will be understood that operation of the invention may not serve its intended purpose if a user fails to align a centerline 1020 of reader 5 with a symbol the user intends to decode. That is, if a user believes he has aligned centerline 1020 with a symbol intended to be decoded, but in reality has aligned reader 5 with a symbol laterally disposed relative to the one intended to be decoded, a reader configured to operate in accordance with the invention will decode the laterally disposed symbol, not the symbol intended to be decoded. The task of aligning centerline 1020 (which may be imaginary or an indicia formed on housing) becomes more difficult at longer reading distances. Accordingly, it can be seen that operation of reader 5 would benefit from the incorporation in reader 5 of means for aiding the alignment of a centerline of reader (which is normally the centerline of image sensor 32) with the symbol a user intends to decode.

Readers having aiming assemblies which include illumination and optics projecting aiming patterns that indicate a horizontal (otherwise termed lateral) center of an aiming pattern and therefore an image field are shown and described in FIGS. 4a and 4b.

In the embodiment of FIG. 4a imaging module 10 is similar to imaging module 10 shown in FIGS. 2c-2e except that imaging module 10 includes a laser diode assembly 60 and mounting assembly 61 for precision mounting of the laser diode assembly 60. LEDs 18 slit apertures 43 and the optics of optical member 26 generate an aiming/illumination pattern 4010 as shown in FIG. 4g. However, illumination/aiming pattern 4010 does not include a pattern feature aiding in the lateral alignment of reader 5 so that a center of a slice image frame (e.g. image map 5010, FIG. 5c) includes a symbol representation desired to be decoded. Laser diode assembly 60 possibly in combination with shaping optics, does however project feature 4012 which aids in the lateral alignment of reader 5. Laser diode assembly 60 can be turned off intermediate frame exposure periods so that light from diode 60d does not affect a captured image. Aspects of laser diode aimer 1D imaging modules, which may project an aiming pattern aiding lateral alignment of a reader 5 are described in greater detail in application Ser. No. 10/252,484 entitled “Long Range Optical Reader” filed Sep. 23, 2002 incorporated herein by reference. The combination of LEDs 18 and laser diode assembly 60 project aiming pattern 4014 including feature 4012 and major body pattern 4010. Though feature 4012 and pattern 4010 may be projected at different times they appear to be simultaneously projected to a user. Center indicating aiming systems described herein project an aiming pattern including at least one feature indicating a lateral center of an aiming pattern. In embodiments of the invention in which image maps are stored, center indicating aiming systems are useful in aiding a user in accomplishing the task of aligning reader 5 so that a representation of the symbol which the user wishes to decode is represented by center pixel values of a captured image map captured by reader 5.

A center indicating aiming pattern can also be provided without adding any additional light sources to the aiming illumination system. FIG. 4c shows a functional schematic view of optical member 26 of module 10 of FIGS. 2c-2e. FIGS. 4d-4f, 4k-4n show modifications which may be incorporated in module 10 which would result in a center of an aiming pattern being indicated. In the embodiment of FIG. 4d, wedges 4050 are superimposed at interior edges of diffusers 27, resulting in light from LEDs 18 being more concentrated toward a center of an image field, and therefore resulting in pattern 4016 being brighter at a center region 4017 thereof. In the embodiment of FIG. 4e, wedges 4052 are superimposed at outer edges of diffuser surfaces 27, creating a similar aiming pattern to the one indicated by FIG. 4h and having a brighter center region 4017. Wedges 4050 and 4052 could also be formed at light exit surface of member 26 or on another optical member. In the embodiment of FIG. 4k wedges 4050 are replaced by decentered spherical or aspherical surfaces 4053. In the embodiment of FIG. 4L, the surface opposite the wedges 4050 are implemented with spherical or aspherical surfaces 5054. In the embodiment of FIG. 4m the spherical or aspherical surfaces 4055 and 4056 are combined to optimize the alignment pattern. The implementations of FIGS. 4k, 4L, and 4m create aiming patterns similar to pattern 4016, FIG. 4h having a brighter center. An imaging module projecting an aiming/illumination pattern having a bulbous center 4021 as shown in FIG. 4i can be realized by incorporating optics in member 256 which directs light vertically up and down in a center region of a target substrate. For example, referring to FIGS. 4c, 4d, and 4k, the magnification of cylindrical lens surface 25 in regions 4070 offset from LEDs 18 can be increased relative to the magnification of the cylindrical lens surface 25 in region 4071. In reality, because of inherent difficulties in manufacturing multiple optical systems so that images are focused at a common point, systems designed to project a brighter center aiming pattern 4016, may project a bulbous center aiming pattern 4020.

An aiming pattern substantially as shown in FIG. 4h can also be provided by incorporating in module 10 a supplemental center aiming system as shown in FIG. 4f comprising outer LEDs 19 and optics 21 laterally offset (axis of LED, a_{L}≠a₂₁, axis of optics 21, from the outer LEDs 19. Optics 21 and 21′ can comprise spherical or aspherical lens surfaces, the curvatures of which may or may not be the same. In a reader 5 including a module 10 as shown in FIG. 4f, reader 5 can be made so that outer LEDs 19 are actuated only if and when the reader 5 is driven into a position dependent decode launch mode as described herein. As indicated previously, reader 5 may be driven into a position dependent decode launch mode either manually in response to a user actuated command (e.g. as described with reference to FIGS. 5d or 5f) or automatically in response to a sensed condition. Outer LEDs 19 may be actuated only intermediate of frame exposure periods so that light from LEDs 19 does not affect the captured image. LEDs 19 may be selected to emit light in color wavelength band different from the emission band of LEDs 18 so that the center of an aiming/illumination pattern is more clearly indicated. As indicated previously, reader 5 may be driven into a position dependent decode launch mode either manually in response to a user actuated command (e.g. as described with reference to FIGS. 5d or 5f) or automatically in response to a sensed condition.

With reference again to module 10 of FIGS. 2c-2e, it has been described herein that a shape of aiming/illumination pattern 4010 is affected by the shape of slit aperture 43 and the shape of baffles 681. Additional shaping features can be incorporated into slit apertures 43 and/or baffles 681 for generating a center indicating feature in an aiming/illumination pattern 4010 projected by module 10. As indicated by the cutaway front view of FIG. 2f, slit apertures 43 can be L shaped so that a lateral center indicating features 4025 are included in a projected aiming pattern 4020. It is noted that the light spreading angle of diffusers 27 (which may also be refractive optic or diffractive optic diffusers as explained in the previously incorporated application Ser. No. 10/093,140 filed Mar. 7, 2002 entitled “Optical Reader Aiming Assembly Comprising Aperture) may have to be adjusted at least for some rays entering member 26, so that a width 4026 of feature 4025 is appropriately narrow. Referring to front view of FIG. 2g, baffles 681 can include feature 2902 for projecting a center indicating feature 4025 on a target substrate as shown in FIG. 4j. The operation of feature 2902 may be enhanced by the incorporation of lensing systems similar to those described with reference to FIG. 4f, elements 21, 21′ but located appropriately behind openings 2902 to image LED slit 43 onto a target. In the embodiments described with reference to FIGS. 2f and 2g the spacing between projected center indicating features 4025 of a projected aiming pattern 4024 will vary depending upon the reader-to-target distance. It is noted that while differences exist as between pattern 4014, 4016, 4020, and 4024, each of patterns 4010, 4016, 4020, and 4024 includes elongated horizontal major body portions.

While the present invention has been particularly shown and described with reference to the preferred mode as illustrated in the drawings, it will be understood by one skilled in the art that various changes in detail may be effected therein without departing from the spirit and scope of the invention as defined by the claims.

We claim:

1. An optical reader comprising:
a multiple pixel one dimensional image sensor, said image sensor generating image signals;
an imaging optics focusing a target image on said image sensor;
a control circuit couples to said image sensor, said control circuit configured, on the actuation of a trigger to:
capture slice frame image data;
search for a decodable symbol representation in said slice of image data;
determine whether said decodable symbol is within a predetermined valid zone; and
launch a decode algorithm for decoding said decodable symbol representation if said control circuit determines that said decodable symbol is within said predetermined valid zone.

2. The reader of claim 1, wherein said control circuit in capturing said slice image data stores an image map and wherein said control circuit when determining whether said symbol representation is in said valid zone determines whether said symbol representation includes pixel positions of a predetermined percent of pixels of said image map centered at a center of said image map.

3. The reader of claim 1, wherein said control circuit in capturing said slice image data stores an image map.

4. The reader of claim 1, wherein said reader is configured so that a width of said valid zone is adjustable via a menu interface.

5. The reader of claim 1, wherein said reader is configures so that a position of said valid zone is adjustable via a menu interface.

6. The reader of claim 1, wherein said aiming pattern projected by said aiming system is an aiming/illumination which includes light sensed by said image sensor.

7. The reader of claim 1, wherein said aiming system is configured so that said aiming pattern includes a center indicating feature.

8. The reader of claim 6, wherein said aiming system includes a laser diode assembly projecting a feature indicating a center of said aiming pattern.

9. The reader of claim 6, wherein said aiming system is devoid of all types of light sources except for LEDs.

10. The reader of claim 6, wherein said projected aiming pattern includes a bulbous center.

11. An optical reader comprising:
a 1D image sensor having a linear pixel array;
an imaging optic focusing an image onto said linear pixel array;
a control circuit in communication with said 1D pixel array, wherein said control circuit is configured to:
capture a slice frame of image data representing said image;
find position data respecting a decodable symbol representation in said captured slice frame of image data; and
utilize said position data in determining whether to launch a decoding algorithm to decode said decodable symbol representation.

12. The reader of claim 11, wherein said control circuit is capturing said slice image data captures an image map.

13. The reader of claim 11, wherein said control circuit in utilizing said position data determines whether said position data is within a valid zone of image data.

14. The reader of claim 11, wherein said control circuit in finding said position data scores said symbol representation according to position and further wherein said control circuit in utilizing said position data scores remaining symbol representations of said image frame according to position and determines whether a position score of said symbol representation is a highest score of said frame.

15. The reader of claim 11, wherein said image sensor includes a 1×N array of pixels.

16. The reader of claim 11, wherein said image sensor includes an M×N, N>>N array of pixels.

17. The reader of claim 11, wherein said image sensor comprises a plurality of pixels, and wherein said control circuit in capturing said slice frame stores an image map comprising a plurality of pixel values, each pixel values corresponding to a pixel of said array.

18. The reader of claim 11, wherein said control circuit in capturing said slice frame captures an image map including plurality of pixel values, and wherein said control circuit in utilizing said position data determines whether said position data is within a valid zone of image data, said valid zone of image data comprising a subset of said pixel values of said slice frame.

19. The reader of claim 18, wherein said subset of pixels of said valid zone is centered about a center of said image map.

20. The reader of claim 11, wherein said aiming system is configured so that said aiming pattern includes a center indicating feature.

21. An optical reader comprising:
an illumination system;
a multiple pixel one dimensional image sensor, said image sensor generating image signals;
an imaging optics focusing a target image on said image sensor;
a control circuit coupled to said image sensor, wherein said control circuit is configured, on a driving of a trigger signal to an ON state, to:
capture slice image data;
locate each symbol representation represented in said image data;
issue each symbol representation in said slice image data a position score; and
launch a decode algorithm decoding a symbol representation of said image data having a highest position score.

22. The reader of claim 21, wherein said control circuit in capturing said slice image data stores an image map.

23. The reader of claim 21, wherein said aiming pattern projected by said aiming system.

24. The reader of claim 21, wherein said aiming system is configures so that said aiming pattern includes a center indicating feature.

25. The reader of claim 24, wherein said aiming system includes a laser diode assembly projecting a feature indicating a center of said aiming pattern.

26. The reader of claim 24, wherein said aiming system is devoid of all types of light sources except for LEDs.

27. The reader of claim 24, wherein said projected aiming pattern includes a bulbous center.

28. An optical reader comprising:
an illumination system projecting an aiming pattern;
a 1D image sensor generating image signals;
a control circuit coupled to said image sensor, wherein said control circuit captures slice image data;
a first “full field” operating mode in which said control circuit decodes a first located symbol of said slice image data;
a second “position dependant decode” operating mode in which said control circuit finds position data of a symbol representation of said slice image data and utilized said position data to determine whether to launch a decode algorithm to decode said symbol representation;
wherein said reader is configured so that a user selects between said first mode and said second mode via a menu interface.

29. The optical reader of claim 28, wherein said reader is configured so that a user selects between said first and second modes by reading a symbol of menu sheet.

30. The optical reader of claim 28, wherein said reader includes a display, and wherein said reader is configured so that a user select between modes by selecting a displayed menu option.
